(19) United States
(12) Patent Application Publication
(10) Pub. No.: US 2010/0074814 A1
(43) Pub. Date: Mar. 25, 2010

(54) REDUCTANT DECOMPOSITION MIXER AND METHOD FOR MAKING THE SAME

(75) Inventor: Jason Drost, Edgerton, WI (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP INC., Minneapolis, MN (US)

(21) Appl. No.: 12/237,574

(22) Filed: Sep. 25, 2008

(51) Int. Cl. B01J 19/18; B23K 31/02; B23Q 3/00

(52) U.S. Cl. 422/225; 228/139; 29/464

(57) ABSTRACT

A reductant decomposition mixer for use in exhaust systems is provided The mixer includes a plurality of mixer bars, a plurality of cross bars and an outer ring. The mixer bars have a plurality of blades and are arranged in parallel to extend in a single direction. The cross bars interlock with the mixer bars from opposing directions and are arranged in parallel to extend in a single direction that is perpendicular to the direction of the mixer bars. The outer ring is connected to the ends of each of the mixer bars and the ends of each of the cross bars.

### FIELD

This disclosure relates to the field of exhaust systems. More particularly, this description relates to a reductant decomposition mixer to be placed within a decomposition reactor.

### BACKGROUND

A common problem associated with the use of internal combustion engines are the formation of undesirable byproducts found in the exhaust stream, particularly nitrogen-oxides. After-treatment systems, such as selective catalytic reaction (SCR) systems, are used to lower the nitrogen-oxide content in the exhaust stream using urea and a reduction catalyst. In some SCR systems a static mixer is placed in a urea decomposition reactor to promote the decomposition of the urea into ammonia.

Typical mixers include a grid made up of mixer bars having blades and cross plates placed between the mixer bars and connected to the sides of the mixer bars using a welding process. The mixer bars and cross plates are typically made of materials such as 18 GA 304L SS, 439L SS and 441L SS. These materials created strength and stability issues when placed in an exhaust system, as conditions seen have high temperatures, are highly corrosive, and highly erosive. Attempts to improve the strength and stability of the mixer were made by placing a perimeter piece around the mixer bars and the cross plates. The perimeter piece was formed by rolling the material into shape that created inwardly formed 90° edges. However, due to the 90° edges, it became necessary to reduce the length of the mixer, thereby reducing the size of the blades on the mixer bar and ultimately the surface area of the blades in which to design the shape of the blades.

### SUMMARY

This application describes a reductant decomposition mixer for use in exhaust systems and methods for manufacturing the same. The mixer uses an interlocking mechanism for connecting a plurality of mixer bars and a plurality of cross bars into a grid. Each mixer bar and cross bar has an indexing element used for arranging the plurality of mixer bars and cross bars. Also, prior to manufacturing each mixer bar and cross bar include ears that provide the correct amount of additional filler material that can be used for welding. The mixer bars are held together by connecting an outer ring around the perimeter of the mixer bars. The cross bars are inserted from alternating directions (one from the front, the next from the back, etc.) to create an interlocked grid of mixer bars and cross bars. This interlocking system eliminates the need for welding at each of the internal intersections between the mixer bars and the cross bars. The outer ring has a linear segment that is used as an indexing feature for orienting the outer ring to the mixer bars and the cross bars during manufacturing.

In one embodiment, a reductant decomposition mixer for use in exhaust systems is provided. The mixer includes a plurality of mixer bars, a plurality of cross bars and an outer ring. The mixer bars have a plurality of blades and are arranged in parallel to extend in a single direction. The cross bars interlock with the mixer bars and are arranged in parallel to extend in a single direction that is perpendicular to the direction of the mixer bars. The outer ring is connected to the ends of each of the mixer bars and the ends of each of the cross bars.

In another embodiment, a method of manufacturing a reductant decomposition mixer is provided. The method includes orienting a plurality of mixer bars, each mixer bar comprising a plurality of blades, and a plurality of equally spaced notches at a top side and at a bottom side of the mixer bar. The method also includes interlocking a plurality of cross bars to the top side and the bottom side of each mixer bar, each cross bar comprising a plurality of equally spaced notches on a same surface of the cross bar to interlock with the notches of the mixer bars. Lastly, an outer ring is connected to the interlocked plurality of mixer bars and cross bars.

### DESCRIPTION OF THE DRAWINGS

FIG. 1 is a top view of a reductant decomposition mixer.

FIG. 2 is a cross sectional view of a mixer bar.

FIG. 3 is a perspective view of the mixer.

FIG. 4 is a side view of the mixer bar prior to manufacturing of the mixer.

FIG. 5 is a side view of the cross bar prior to manufacturing of the mixer.

FIG. 6 is a flow chart of the method for manufacturing the mixer.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice what is claimed, and it is to be understood that other embodiments may be utilized without departing from the spirit and scope of the claims. The following detailed description is, therefore, not to be taken in a limiting sense.

The embodiments presented herein are directed to a reductant decomposition mixer to be placed in a SCR urea decomposition reactor in an exhaust system. The mixer is formed so as to be capable of decomposing nitrogen-oxide reductant from the exhaust stream traveling through the decomposition reactor. The mixer uses an array of mixing bars formed with blades that can create a turbulent flow for the liquid passing through the mixer and explodes the droplets into smaller particles. The mixer also creates a large surface area for the transfer of heat from the exhaust to the reductant (urea) to promote decomposition. Also, all of the components of the mixer are composed of 16 gauge 904L stainless steel. This material has a high content of alloying materials that provide superior corrosion and erosion prevention characteristics when placed in a decomposition reactor or any similar environment that is highly corrosive and subject to high temperatures, cyclic temperatures, etc.

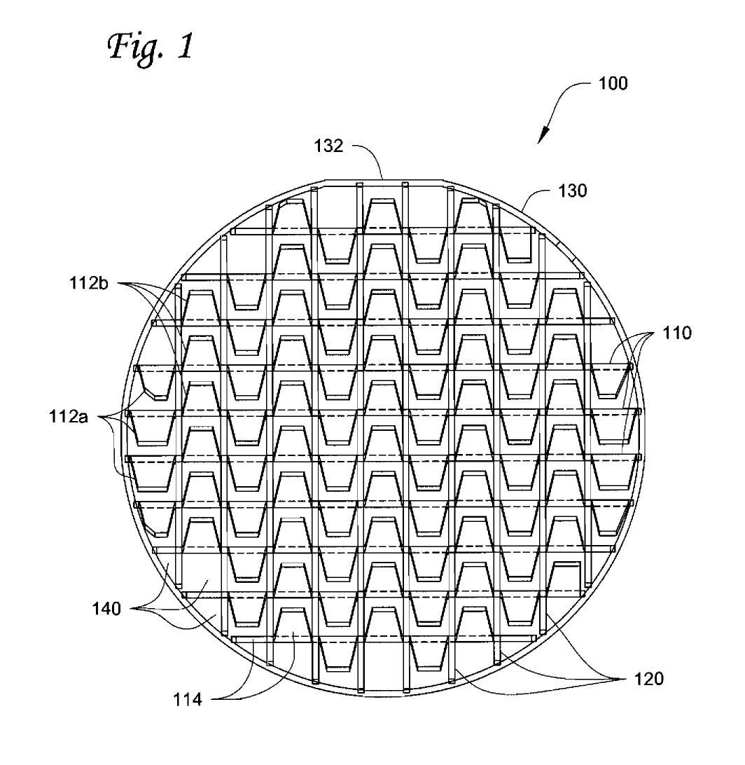

FIG. 1 is a top view of a reductant decomposition mixer 100 according to one embodiment. The mixer 100 is made up of a plurality of equally spaced mixer bars 110 arranged in parallel and extending along the same axis and a plurality of equally spaced cross bars 120 that are arranged in parallel and perpendicular to and interconnected with the mixer bars 110. As discussed in more detail below, the mixer bars 110 and the cross bars 120 are interconnected using an interlocking mechanism in which cross bars 120 are connected to the mixer bars 110 from opposing directions. By using an interlocking mechanism, the mixer bars 110 are connected to the cross bars 120 without welding at each point of contact.

The mixer 100 also includes an outer ring 130 connected to the ends of the mixer bars 110 and the cross bars 120 to support the mixer bars 110 and the cross bars 120. The outer ring 130 holds the mixer bars 110 and the cross bars 120 together structurally and holds the mixer 100 in place when the mixer 100 is fit into a tube or tube-like assembly (not shown). The outer ring 130 also includes an indexing feature 132 in the form of, for example, a linear segment to prevent incorrect installation of the outer ring 130 during manufacturing of the mixer 100.

The layout of the mixer bars 110, the cross bars 120 and the outer ring 130 form a plurality of open spaces 140 that allows the exhaust stream to pass there through. In one embodiment, the open spaces 140 formed by the mixer bars 110 and the cross bars 120 have a dimension of approximately 9.5 mm×9.5 mm.

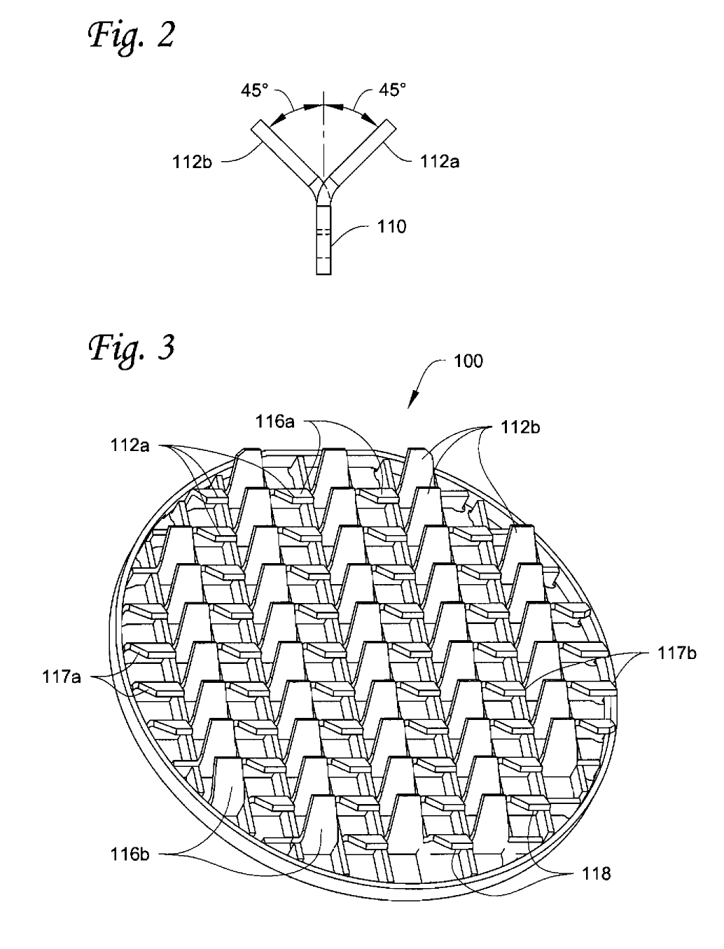

Each of the plurality of mixer bars 110 is formed with a plurality of equally spaced blades 112a, b extending from a top side 114 of each of the mixer bars 110. In one embodiment, each blade 112a is formed to be directly adjacent to at least one of the blades 112b and to extend from the top side 114 of its mixer bar 110 at an approximate angle of 45° from an axis perpendicular to the top side 114 of the mixer bar 110. Also, in this embodiment each blade 112b is formed to be directly adjacent to at least one of the blades 112a and to extend from the top side 114 of its mixer bar 110 at an approximate angle of −45° from an axis perpendicular to the top side 114 of the mixer bar 110. In other embodiments, the angles of each blade 112a, 112b can be varied. FIG. 2 provides a cross sectional view of one of the mixer bars 110 that more clearly shows the angle and orientation of the blades 112a, b.

FIG. 3 provides a perspective view of the mixer 100 that more clearly shows the shape of the blades 112a, b. The blades 112a, b include two opposing surfaces 116a, b that are substantially trapezoidal, two opposing edges 117a, b and a top edge 118 that are substantially rectangular. The size, shape and angle of blades 112a, b create a turbulent flow when exhaust stream passes through the mixer 100 and causes the reductant to mix with the exhaust stream to disperse the reductant evenly to promote decomposition. The size, shape and angle of blades 112a, b also provides a large surface area for the transfer of heat from the exhaust to the reductant (urea) to promote decomposition. The size, shape and angle of blades 112a, b further provides a surface for the reductant (urea) to contact and explode into smaller particles

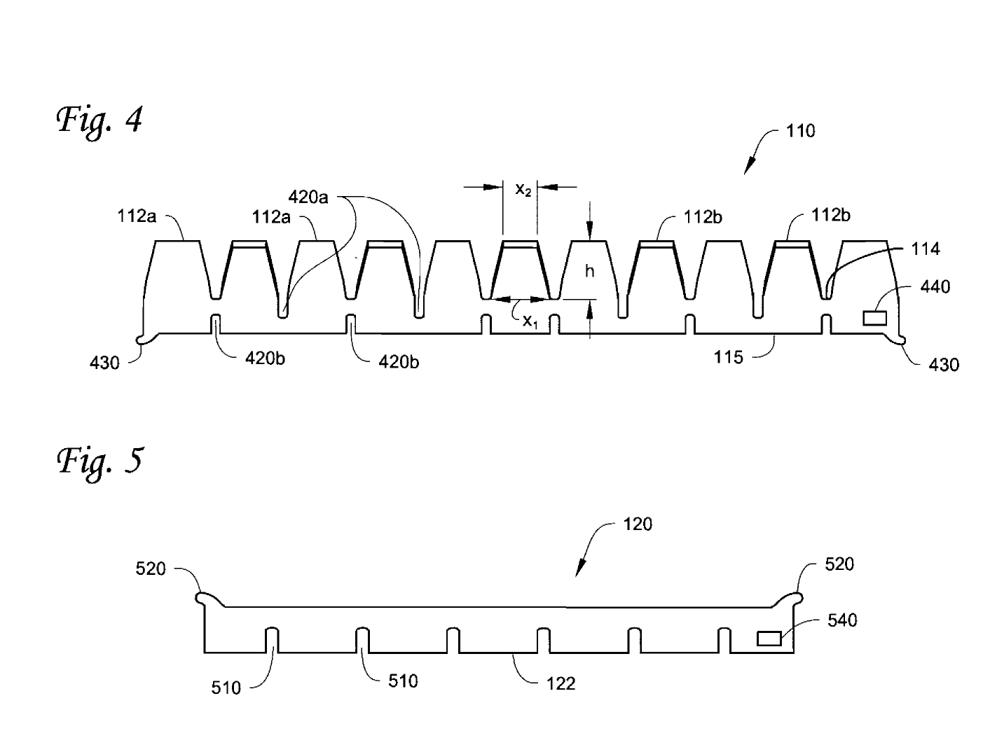

FIG. 4 is a side view of the mixer bar 110 prior to manufacturing of the mixer. The mixer bar 100 includes a plurality of blades 112a, b extending from the top side 114 of the mixer bar 110. As described above with respect to FIGS. 1 and 2, each blade 112a is formed to be directly adjacent to at least one of the blades 112b and to extend from the top side 114 of the mixer bar 110 at an approximate angle of 45° from an axis perpendicular to the top side 114 of the mixer bar 110. Also, each blade 112b is formed to be directly adjacent to at least one of the blades 112a and to extend from the top side 114 of the mixer bar 110 at an approximate angle of −45° from an axis perpendicular to the top side 114 of the mixer bar 110. Also, each blade 112a, b has a length x₁ of approximately 10 mm near the bottom of the blade 112a, b and a length x₂ of approximately 6 mm at the top of the blade 410a, b. Also, a height h from the top of the blade 410a, b to the bottom of the blade 410a, b is approximately 11.5 mm. In other embodiments, the lengths x₁, x₂ and the height h of each blade 112a, 112b can be varied.

The mixer bar 110 also has an interlocking mechanism that includes a plurality of equally spaced notches 420a, b. The notches 420a are located at the top side 114 of the mixer bar 110 and between the blades 112a, b. The notches 420b are located at a bottom side 115 of the mixer bar 110 and between the blades 112a, b. During manufacturing, the notches 420a allow a plurality of cross bars to interlock with the mixer bar 110 at each notch 420a from the top and the notches 420b allow a plurality of crossbars to interlock with the mixer bar 110 at each notch 420b from the bottom. By interlocking cross bars on both sides of the mixing bar 110, the structural strength and stability of a mixer is increased and the necessity of welding each point of contact between the mixing bar 400 and a plurality of cross bars is eliminated. Also, by using the interlocking mechanism described above, the number of welds required to manufacture a mixer is substantially reduced saving manufacturing costs. Furthermore, the stability of the mixer is increased when placed in conditions where thermal expansion and contraction may occur, e.g., an exhaust system.

The mixer bar 110 further includes ears 430 located near the ends and near the bottom 115 of the mixer bar 110 and an indexing feature 440 near one end of the mixer bar 110. In one embodiment, the indexing feature is a Bill of Material (“BOM”) number stamped into each mixer bar 110 that allows the assembler to easily identify and place the mixer bars 110 in the correct location in the welding fixture. The ears 430 provide additional filler material that can be used to weld the ends of the mixer bar 110 to each point of contact with an end of a cross bar and/or a point on the outer ring. The ears 430 are designed to provide a sufficient amount of filler material needed to form a sufficient weld without any excess material of the ears 430 left after welding.

FIG. 5 is a side view of a cross bar 120 prior to manufacturing of a mixer, according to one embodiment. The cross bar 120 has an interlocking mechanism including a plurality of equally spaced notches 510 located at one side 122 of the cross bar 120 for interlocking with a plurality of mixer bars. The cross bar 120 also includes an indexing feature 540 near one end of the mixer bar 110 and ears 520 located near the ends and near the top of the cross bar 120. In one embodiment, the indexing feature 540 is a BOM number stamped into each cross bar 120 that allows the assembler to easily identify and place the cross bars 120 in the correct location in the welding fixture. The ears 520 provide additional filler material that can be used to weld the ends of the cross bar 120 to each point of contact with an end of a mixer bar and/or a point on the outer ring. The ears 520 are designed to provide a sufficient amount of filler material needed to form a sufficient weld without any excess material of the ears 520 left after welding. During manufacturing, the cross bar 120 can interlock with a plurality of mixer bars, such as the mixer bar 110, at the top side of the mixer bars or at the bottom side of the mixer bars, as all of the notches 510 are located at one side 122 of the cross bar 500.

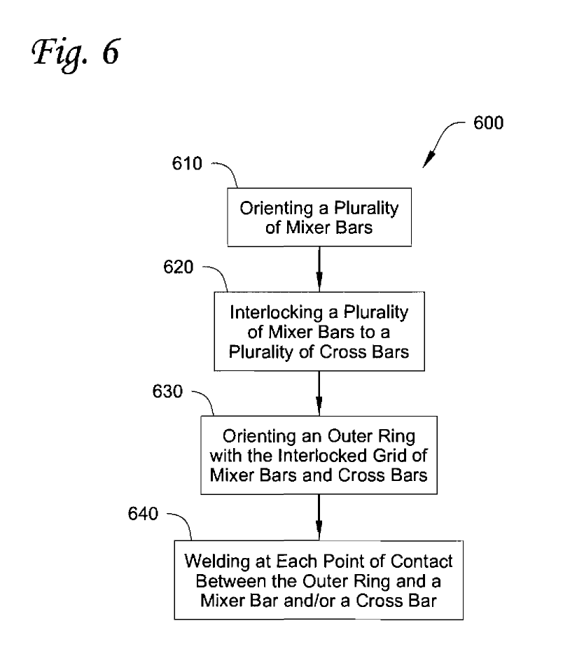

FIG. 6 is a flow chart of a method 600 for manufacturing the mixer. The method 600 begins at 610 where a plurality of bottom cross bars, similar to the cross bar 120 shown in FIG. 5, to be placed on a bottom side of the mixer are arranged in a copper welding fixture based on each bottom cross bar's indexing feature. The method 600 then proceeds to step 620. At 620, a plurality of mixer bars, similar to the mixer bar 120 shown in FIG. 4, are arranged in the copper welding fixture perpendicularly to the plurality of bottom cross bars based on each mixer bar's indexing feature and connected to the plurality of bottom cross bars by interlocking the notches at the bottom side of each mixer bar to a notch of more than one of the bottom cross bars. The method 600 then proceeds to step 630. At step 630, a plurality of top cross bars, similar to the cross bar 120 shown in FIG. 5, to be placed on the top side of the mixer bars are arranged in the copper welding fixture based on each top cross bar's indexing feature and connected to the plurality of mixer bars by interlocking the notches of each top cross bar to a notch at the top side of more than one of the mixer bars. By interlocking cross bars to both notches located at the top side of the mixer bars and notches located at the bottom side of the mixer bars, a strong and stable mixer is achieved without requiring a weld at every contact between a mixer bar and a cross bar. The method 600 then proceeds to step 640. At step 640, an outer ring is arranged in the copper welding fixture around the interlocked mixer bars and cross bars to provide further support and strength to the mixer. Also at step 640, the points of contact between the outer ring and an end of one of the mixer bars and/or one of the cross bars are welded together using the ears provided on the mixer bar and/or the cross bar as filler material for the weld contacts. The copper welding fixture is used to absorb heat from welding in order to prevent distortion of the mixer. However, in other embodiments, other types of welding fixtures may be used or, in some embodiments, no welding fixture is used. In one embodiment, the welding is performed using a robotic plasma welder for automation.

The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A reductant decomposition mixer comprising:
a plurality of mixer bars arranged in parallel to one another to extend in a first direction, each mixer bar including a plurality of blades;
a plurality of cross bars arranged in parallel to one another to extend in a second direction perpendicular to the first direction and interlocked with the plurality of mixer bars from opposing directions;
an outer ring connected to an end of each of the plurality of mixer bars and an end of each of the plurality of cross bars.

2. The mixer of claim 1, wherein each of the mixer bars includes a plurality of notches at a top side of the mixer bar and a plurality of notches at a bottom side of the mixer bar, and each cross bar includes a plurality of notches at a same side of the cross bar for interlocking each cross bar to a notch on either the top side or the bottom side of each mixer bar.

3. The mixer of claim 1, wherein the outer ring includes an indexing feature that is used to orient the outer ring during manufacturing of the mixer.

4. The mixer of claim 1, wherein each of the plurality of mixer bars has an indexing feature used to orient the mixer bar during manufacturing of the mixer.

5. The mixer of claim 1, wherein the blades of each mixer bar include a plurality of first blades extending from a top side of the mixer bar at an angle of approximately 45° from an axis normal to the top side and a plurality of second blades extending from the top side at an angle of approximately −45° from the axis normal to the top side.

6. The mixer of claim 1, wherein each blade includes a first pair of substantially trapezoidal opposing surfaces, a second pair of substantially rectangular opposing edges and a substantially rectangular top edge.

7. The mixer of claim 1, further comprising a plurality of open spaces formed by the arrangement of the mixer bars and the cross bars, the open spaces having a dimension of approximately 9.5 mm by 9.5 mm.

8. The mixer of claim 1, wherein the length of each of the blades is approximately 10 mm near a bottom of the blade and approximately 6 mm at atop of the blade.

9. The mixer of claim 1, wherein a height of each of the blades is approximately 11.5 mm from a bottom of the blade to a top of the blade.

10. The mixer of claim 1, wherein the plurality of mixer bars, the plurality of cross bars and the outer ring are composed of 16 gauge 904L stainless steel.

11. A method of manufacturing a reductant decomposition mixer, comprising:
orienting a plurality of mixer bars, each mixer bar comprising a plurality of blades, a plurality of equally spaced notches at a top side and at a bottom side of the mixer bar:
interlocking a plurality of cross bars to the top side and the bottom side of each mixer bar, each cross bar comprising a plurality of equally spaced notches configured to interlock with the notches of the mixer bars;
connecting an outer ring to the interlocked plurality of mixer bars and cross bars.

12. The method of claim 11, wherein the outer ring comprises an indexing feature for orienting the outer ring when connecting the outer ring to the interlocked plurality of mixer bars and cross bars.

13. The method of claim 11, comprising using an ear extending at a first end and a second end of each mixer bar as additional filler material to connect the outer ring to the interlocked plurality of mixer bars and cross bars by welding each point of contact between the outer ring and one of the plurality of mixer bars and/or one of the plurality of cross bars.

14. The method of claim 11, comprising using an ear extending at a first and second end of each cross bar as additional filler material to connect the outer ring to the interlocked plurality of mixer bars and cross bars by welding at each point of contact between the outer ring and one of the plurality of mixer bars and/or one of the plurality of cross bars.

15. The method of claim 11, wherein orienting the plurality of mixer bars comprises arranging each of the plurality of mixer bars based on an indexing feature formed on each of the plurality of mixer bars.

16. The method of claim 11, wherein the outer ring is connected to the interlocked plurality of mixer bars and cross bars using a robotic plasma welder.

17. A reductant decomposition mixer manufactured using the method of claim 11.
